(19) United States
(12) Patent Application Publication
(10) Pub. No.: US 2008/0113543 A1
(43) Pub. Date: May 15, 2008

(54) Waterproof Connector

(75) Inventors: Takeshi Tsuji, Yokkaichi-shi (JP); Michiaki Okamoto, Yokkaichi-shi (JP); Hiroki Hirai, Yokkaichi-shi (JP); Chikahiro Yoshioka, Yokkaichi-shi (JP)

Correspondence Address: OLIFF & BERRIDGE, PLC, P.O. BOX 320850, ALEXANDRIA, VA, 22320-4850, US

(73) Assignee: Autonetworks Technologies, Ltd., Yokkaichi-shi (JP)

(21) Appl. No.: 11/667,074

(22) PCT Filed: Nov. 16, 2005
(86) PCT No.: PCT/JP05/21004

§ 371 Date: May 4, 2007

(30) Foreign Application Priority Data
Nov. 17, 2004 (JP) 2004-333422

(51) Int. Cl. H01R 13/52

(52) U.S. Cl. 439/271

(57) ABSTRACT

A object of the present invention is to enable a double-locking of female terminals without making a whole connector larger in size or complicating a structure thereof while maintaining fine waterproof function. A female connector C1 includes a female housing 12 for retaining a female terminal 10 and a seal member holder 16. The seal member holder 16 retains a seal member 14 having through holes 14a. When the seal member holder 16 is completely attached to the female housing 12, the seal member 14 comes in close contact with a front surface of the female housing 12. In this state, a male terminal 20 of a male connector C2 fits into the female terminal 10 so that a projecting portion 25 of the connector C1 comes in close contact with an inner surface of the through hole 14a to make terminals waterproof individually Further, the seal member holder 16 is provided with a double-locking piece 16f in, which pursues the double locking of the female terminal 10 in the female housing 12 at the time of the complete attachment.

### TECHNICAL FIELD

The present invention relates to a waterproof connector having a function to waterproof each terminal individually.

### BACKGROUND ART

It is generally recognized that a conventional waterproof connector is provided with a seal member surrounding a plurality of terminal accommodating chambers and collectively waterproofs the entire terminal accommodating chambers with the seal member. However, such configuration requires a space for mounting the seal member to be secured on further exterior side from each terminal accommodating chamber, and this causes a disadvantage that a size of the whole connector becomes larger in a direction perpendicular to an axial direction of the connector. Therefore, to make the size of the connector be small, a waterproof connector having an individual waterproof function as described in the below-listed patent document 1 has been under development.

As shown in FIG. 9, the waterproof connector includes a female connector C1 in which a plurality of female terminals 110 are retained by a female housing 112, and a male connector C2 in which male terminals 120 to be inserted respectively to the female terminals 110 are retained by a rear section 122.

The female housing 112 of the female connector C1 includes terminal accommodating chambers 112c for accommodating the female terminals 110 respectively, and lances 113 for locking the female terminals 110 respectively in the terminal accommodating chambers 112c. Further, the female housing 112 has a housing front wall 112a formed with male terminal insertion holes 112b into which the male terminals 120 to fit into the female terminals 110 respectively are insertable from the front side. Further, a seal member 114 made of an elastic member such as rubber has close contact with the housing front wall 112a, and a seal member holder 116 is attached to a front end portion of the female housing 112 so as to cover the seal member 114 from the front side. The seal member 114 is formed with through holes 114a aligned respectively with the terminal insertion holes 112b. Similarly, a front wall of the seal member holder 116 is formed with projection through holes 116a aligned respectively with the through holes 114a.

On the rear side of each female terminal 110, a seal member 118 comes in close contact with an electric wire W onto which the female terminal 110 is crimped, to accomplish waterproofing.

On the other hand, the male connector C2 is a connector mountable onto a substrate in the drawing example. Each male terminal 120 in the male connector C2 has a pin-like shape. The male terminal 120 has one end portion as a mounting portion 120a to be mounted on a substrate P, and the other end as an electric connection portion 120b to fit into a corresponding female terminal 110. The rear section 222 integrally includes a main body wall 123 for retaining the middle portion of the male terminal 120, and a hood 124 covering the end portion of the male terminal 120 as the electric connection portion 120b projecting from the main body wall 123. The female housing 112 and the seal member holder 116 to be mounted thereto are insertable to the hood 124. Further, in the hood 124, there are formed projecting portions 125 projecting from a front surface 123a of the main body wall 123 for respective male terminals 120. Each projecting portion 125 has a shape to surround a predetermined portion of the respective male terminal 120, and has an external diameter such that the projecting portion 125 can be inserted into the projection through hole 116a of the seal member holder 116 and come in close contact with an inner surface of each of the through hole 114a of the seal member 114.

In such waterproof connector, when the electric connection portion 120a of each of the male terminals 120 is inserted to the female terminal 110 through the male terminal insertion hole 112b, each projecting portion 125 of the rear section 222 is press-inserted into each of the through holes 114a of the seal member 114 through each of the projection through hole 116a of the seal member holder 116 and comes in close contact with an inner surface of the through hole 114a thus making each of the terminals 110, 120 waterproof individually.

### Patent Document: Japanese Unexamined Patent Publication No. 2003-297479.

### DISCLOSURE OF THE INVENTION

In the female connector C1, in order to ensure the locking of the female terminal 110 in the female housing 112, it is preferable that a double-locking should be pursued in addition to the locking of the female terminal 110 with the lance 113. Means for pursuing such double-locking includes the way of providing a retainer insertion hole in the female housing 112 and inserting a double-locking retainer (for example, a retainer for retaining the lance 113 at a terminal-locking position) into the retainer insertion hole.

However, the addition of such retainer insertion hole and retainer enlarges and complicates the structure of the connector, and increases passages allowing immersion of water into the female housing 112, thus causing a disadvantage that another structure for waterproofing is required to be added.

In view of such circumstances, the technical object of the present invention is to enable double-locking of female terminals without making a whole connector be larger in size or complicating a structure thereof while maintaining a fine waterproof function.

As a way of attaining the above-described object, the present invention includes a waterproof female connector which is to be connected with a male connector, the male connector being provided with a plurality of male terminals each having a front end portion as an electric connection portion, the male terminal projecting forward and held by a male housing, the male housing being formed with projections each projecting from a front surface of the male housing for a corresponding male terminal to cover a rear part of an electric connection portion The waterproof female connector comprises: a plurality of female terminals into which the electric connection portions of the male terminals can fit respectively, a female housing including: terminal accommodating chambers for accommodating the female terminals respectively, terminal locking portions for locking the female terminals in the terminal accommodating chambers respectively, and male terminal insertion holes into which the male terminals to fit into the female terminals can be inserted respectively, the male terminal insertion holes being formed in front of the female terminals; a waterproof seal member made of an elastic material having a shape coming in close contact with a front surface of the female housing; and a seal member holder for holding the waterproof seal member, the seal member being operable to be attached to the female housing in the state the waterproof seal member comes in close contact with the front surface of the female housing. The waterproof seal member is formed with through holes corresponding to the respective male terminal insertion holes of the female housing and has a shape which allows an inner surface of the through hole to come in close contact with an outer surface of the projection of the male housing to prevent immersion of water into the male terminal insertion hole. The seal member holder has double-locking portions which are to be inserted into the female housing from a front side thereof when the seal member holder is attached to the female housing, the double-locking portions pursue double locking of the female terminals to the female housing in the state where the seal member holder is completely attached to the female housing.

In this configuration, when the seal member holder is completely attached to the female housing in the state where each of the female terminals is inserted to each of the terminal accommodating chamber of the female housing and locked by the terminal locking portion, the waterproof seal member retained by the seal member holder comes in close contact with the front surface of the female housing, and the double-locking portion of the seal member holder pursues double-locking of the female terminal in the state of being placed into the female housing from the front side. Then, the male terminal on the side of the male connector is inserted into the through hole of the waterproof seal member and the male terminal insertion hole on the back side, to make the electric connection portion of the male terminal fit into the female terminal. This allows the terminals to electrically communicate with each other, and makes a close contact between the outer surface of the projection of the male housing covering the rear portion of the electric connection portion of the male terminal and the inner surface of the through hole of the waterproof seal member to waterproof each terminal individually.

In other words, this configuration gives the seal member both the function of retaining the waterproof seal member and the function of pursuing the double-locking of the female terminal to enable the double-locking of the female terminal without making a whole connector larger in size or complicating a structure thereof while maintaining a fine waterproof function.

### BRIEF DESCRIPTION OF THE DRAWINGS

FIG. 1 is a side sectional view showing a connection state of a waterproof connector according to an embodiment of the present invention.

FIG. 2A is a front view showing a female housing of a female connector constituting the waterproof connector, and FIG. 2B is a side sectional view of the same.

FIG. 3A is a front view showing a seal member holder of the female connector, and FIG. 3B is a side sectional view of the same.

FIG. 4A is a side sectional view showing the state where the seal member holder of the female connector is positioned at a temporal locking position, and FIG. 4B is a side sectional view showing the state where the seal member holder is positioned at a complete locking position.

FIG. 5A is a side sectional view showing a rear section of a female housing of a male connector constituting the waterproof connector, and FIG. 5B is a front view showing the rear section.

FIG. 6A is a side sectional view showing a front section of the male housing, and FIG. 6B is a front view of the same.

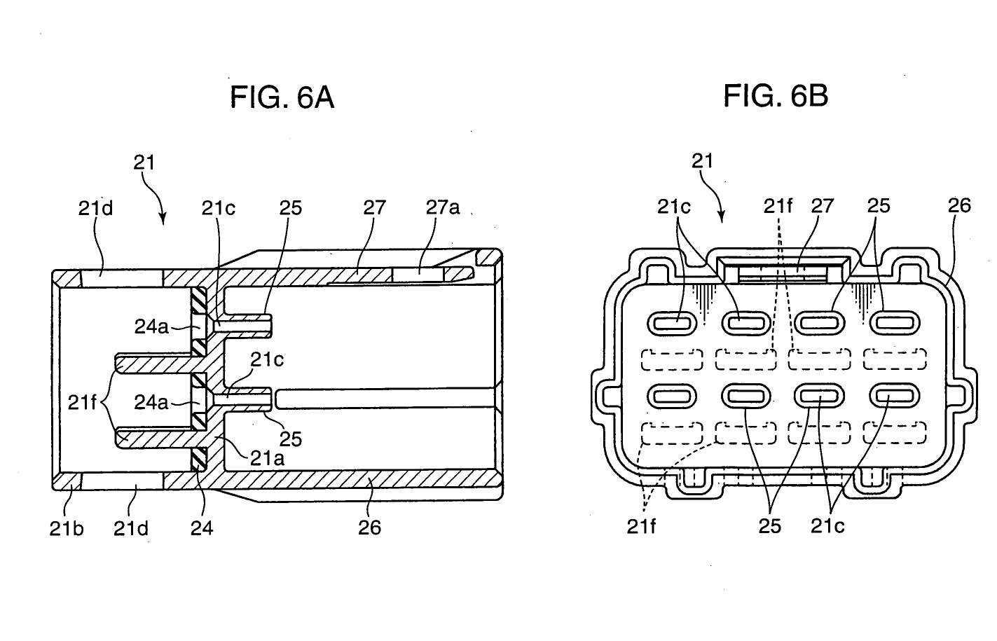

FIG. 7A is a side sectional view showing the state where the front section of the male connector is positioned at a temporal locking position, and FIG. 7B is a side sectional view showing the state where the front section is positioned at a complete locking position.

FIG. 8A is a side sectional view showing an example of a relay connector for connecting the female connector with another female connector, and FIG. 8B is a side sectional view showing the state where the female connectors are connected with each other with the relay connector.

FIG. 9 is a side sectional view showing an example of a conventional waterproof connector.

### BEST MODE EMBODIMENT FOR CARRYING OUT THE INVENTION

A preferred embodiment of the present invention will be described with reference to the drawings.

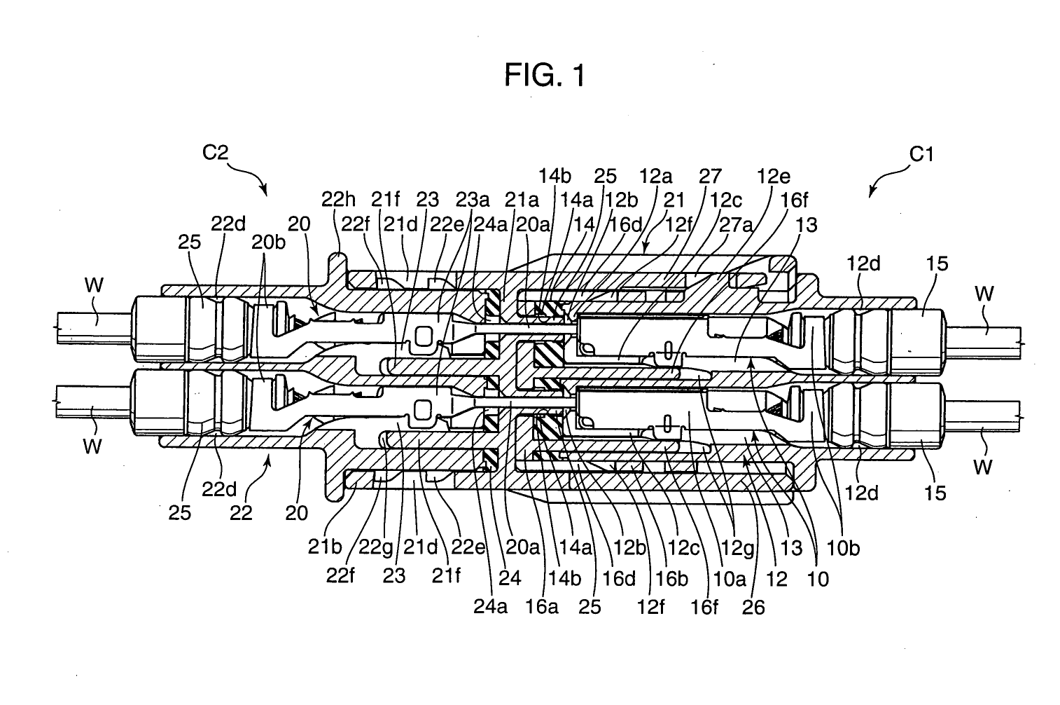

The waterproof connector shown in FIG. 1 includes a waterproof female connector C1 (hereinafter, simply referred to as “female connector C1”) in which a plurality of female terminals 10 are retained by a female housing 12, and a waterproof male connector C2 (hereinafter, simply referred to as “waterproof male connector C2”) in which male terminals 20 to fit into the respective female terminals 10 are retained by the male housings 21, 22. Specific configurations and assembling procedures for the connectors C1, C2 are as follows.

### 1) Specific Configuration of the Female Connector C1

Each female terminal 10 of the female connector C1 integrally includes a female type electric connection portion 10a and a barrel portion 10b formed on the rear side. The barrel portion 10b is bent to be crimped onto an end of an electric wire W. Further, on the immediate rear side from the female terminal 10, a rubber stopper 15 for waterproofing is mounted.

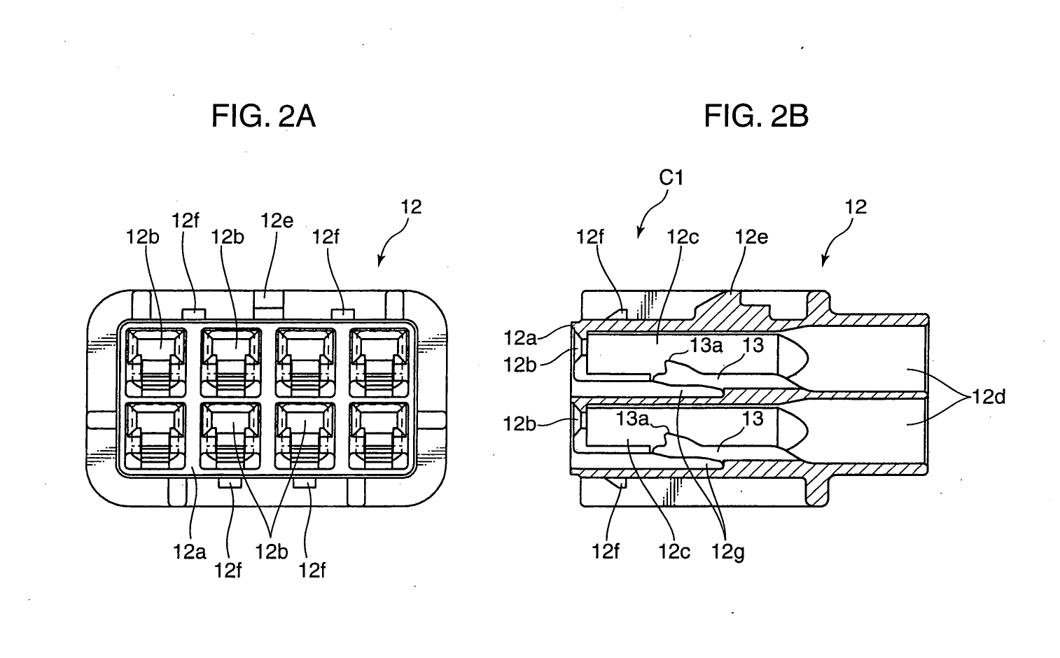

On the other hand, as shown in FIGS. 2A and 2B, the female housing 12 of the female connector C1 includes terminal accommodating chambers 12c accommodating the female terminals 10 respectively. Each terminal accommodating chamber 12c extends in an axial direction (forward and backward directions of the connector), and on the rear side (on the right side in FIG. 2B) thereof, there is formed a rubber stopper press-in hole 12d having a shape (for example, shape of a circular in cross section) to allow the rubber stopper 15 to be press-inserted thereinto. Further, the female housing 12 has a front wall 12a, which is formed with male terminal insertion holes 12b connected to the terminal accommodating chambers 12c respectively As will be described hereinafter, the male terminals 20 can be inserted respectively into the male terminal insertion holes 12b from the front side.

In each terminal accommodating chamber 12c, there is formed a lance 13 having a shape operable to lock a female terminal 10. Specifically, the lance 13 has a cantilevered crossbeam-like shape extending from a bottom surface of the terminal accommodating chamber 12c toward the front side (the left side in FIG. 2B), and has a terminal locking projection 13a projecting upward from the end portion of the lance 13. The lance 13 can be flexibly deformed in upward and downward directions to be shifted between a locking position where the terminal locking projection 13a is inserted into a through hole formed in a bottom wall of the female terminal 10 to lock the female terminal 10 (a position shown in FIG. 1) and a lock releasing position where the terminal locking projection 13a retreats downward from the locking position.

The female housing 12 has a ceiling wall which is provided with a connector connection locking projection 12e projecting upward. Each of the ceiling wall and the bottom wall is formed with a holder locking projection 12f projecting upward and downward at a front side of the connector connection locking projection 12e.

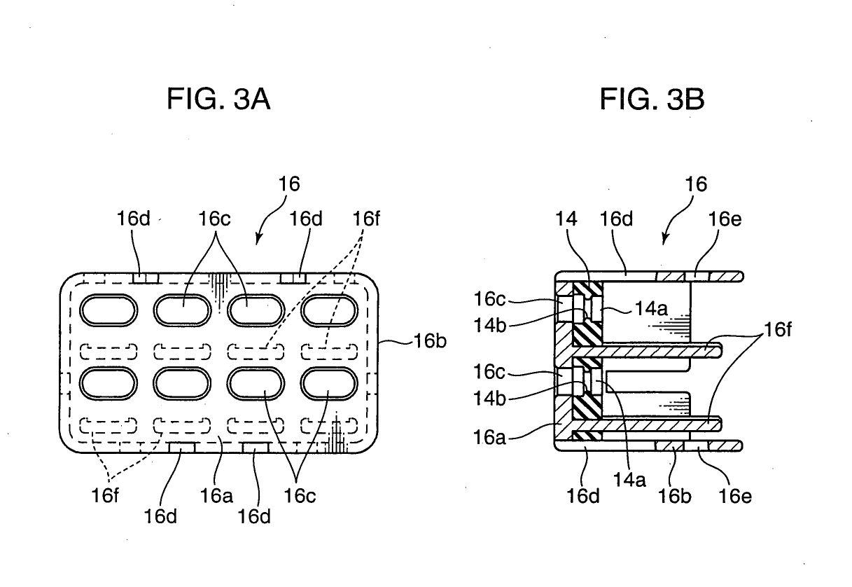

Further, as shown in FIGS. 3A and 3B, a sealing member holder 16 for retaining the waterproof seal member 14 can be attached to the front side of the female housing 12.

The seal member holder 16 has a cap-like shape integrally including a front side wall 16a having a shape operable to cover the front surface of the female housing 12 and a peripheral wall 16b extending from a periphery of the front side wall 16a to the rear side i.e. the side of the female housing 12.

The front side wall 16a is formed with projecting portion insertion holes 16c at positions corresponding to the male terminal insertion holes 12b respectively, into which the projecting portions 25 formed in the male housing 21 described hereinafter can be inserted respectively.

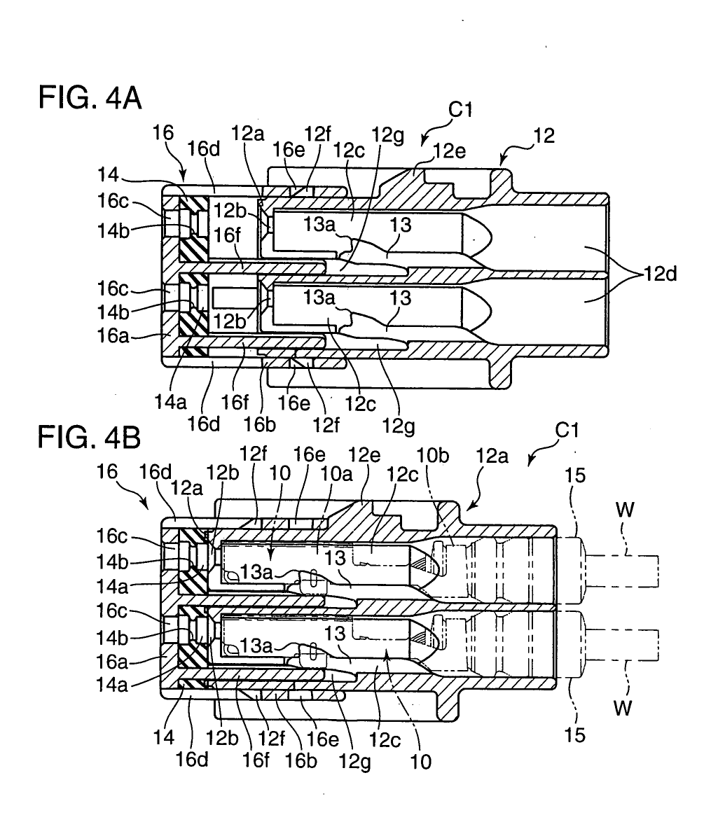

The peripheral wall 16b has a shape operable to fit at the outside of a front portion of the female housing 12, and is formed with elongate through holes 16d extending forward and backward and through holes 16e on the rear side of the elongate through holes 16d in each of an upper portion and a lower portion of the female housing 12. The elongate through holes 16d and the through holes 16e are formed at positions where the holder locking projection 12f of the female housing 12 can fit into either of the holes 16e, 16f. The seal member holder 16 has a temporal locking position where the holder locking projection 12f fits into the through hole 16e as shown in FIG. 4A respectively, and a complete locking position where the holder locking projection 12f fits into a rear end of the elongate through hole 16d and a rear end of the peripheral wall 16b comes in contact with the connector connection locking projection 12e (a position where the seal member holder 16 is completely attached to the female housing 12).

In other words, in the present embodiment, the holder locking projections 12f are used as both a temporal locking portion for retaining the seal member holder 16 at the temporal locking position and a complete locking portion for retaining the holder 16 at the complete locking position.

The seal member 14 is formed out of an elastic member such as rubber or the like in the shape of a sheet and is fastened on a substantially whole back surface of the front side wall 16a of the seal member holder 16. The seal member 14 has through holes 14a formed at positions corresponding to the male terminal insertion holes 12b and projection insertion holes 16c respectively An inner surface of the through hole 14a has a close contact projecting portion 14b projecting inward in an entire circumference at an intermediate position in an axial direction of the through hole 14a As shown in FIGS. 1 and 4B, the seal member 14 comes in close contact with the front surface of the housing front wall 12a in the state where the seal member holder 16 is completely attached to the female housing 12 (in other words, in the state where the seal member holder 16 is retained at the complete locking position).

It should be noted that means for fastening the seal member 14 to the seal member holder 16 is not especially limited. Means of press fitting, bonding or the like may be used, and the seal member 14 may be integrally formed on the seal member holder 16 by double-molding.

Further, as a feature of the female connector C1, the seal member holder 16 has a function of doubly-locking of the female terminal 10 to the female housing 12.

Specifically, the seal member holder 16 has a plurality of double-locking pieces 16f corresponding to the terminal accommodating chambers 12c respectively and penetrating from the rear side of the front side wall 16a of the seal member holder 16 toward the rear side in an axial direction (in other words, toward the side of the female housing 12) through the seal member 14. On the other hand, the female housing 12 is provided with insertion slots 12g each having a shape to allow the double-locking pieces 16f to be inserted thereinto respectively from the front surface side. Each insertion slot 12g reaches a position immediately under each of the lances 13. Then, the double-locking pieces 16f are inserted to the respective insertion slots 12g, so that the seal member holder 16 reaches the complete locking position, where each double-locking piece 16f penetrates under each of the lances 13 to hold the lance 13 at the locking position (in other words, at the position where the terminal locking projection 13a of each lance 13 fits into a through hole of the female terminal 10).

### 2) Specific Configuration of the Male Connector C2

Each male terminal 20 of the male connector C2 integrally includes a tab 20a and a barrel portion 20b formed on the rear side of the tab 20a The tab 20a has an extremity end formed as a male type electric connection portion 20c operable to fit into the electric connection portion 10a of the female terminal 10. The barrel portion 20b is bent to be crimped onto an end of an electric wire W. On immediate rear side thereof, a rubber stopper 25 for waterproofing is mounted.

On the other hand, a male housing of the male connector C2 is, for molding it, divided into a front section 21 and a rear section 22, which hold a seal member 24 therebetween.

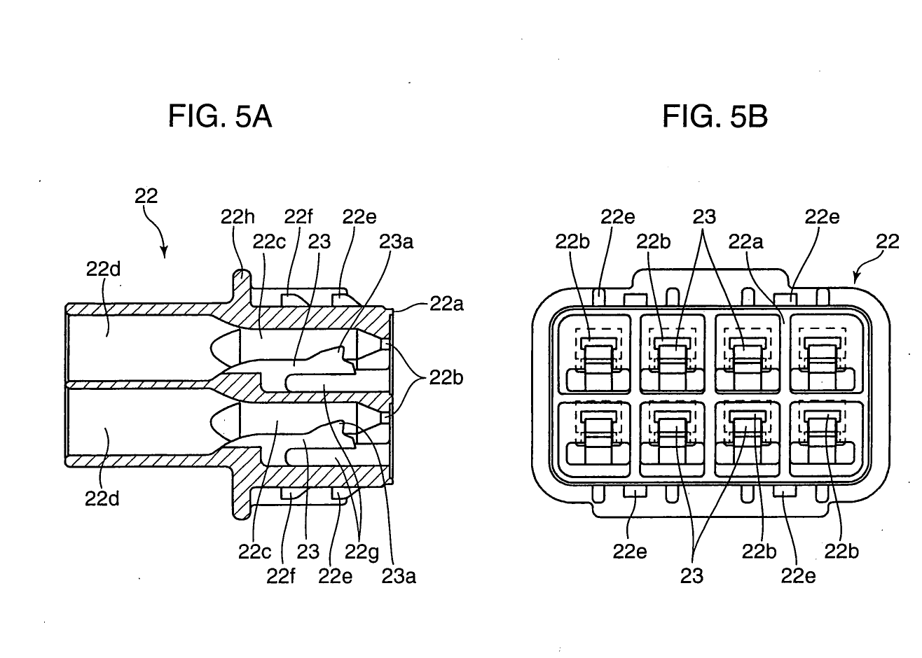

As shown in FIGS. 5A and 5B, the rear section 22 has terminal accommodating chambers 22c for accommodating the male terminals 20 respectively Each terminal accommodating chamber 22c extends in an axial direction (forward and backward direction of the connector), and on the rear side thereof (on the left side in FIG. 5A), there are formed rubber stopper press-in holes 22d each having a shape (ex. a shape with a circular cross section) to allow the rubber stopper 25 to be inserted without a gap. The rear section 22 has a front wall, which are formed with male terminal leading-out holes 22b for respectively leading out tabs of the male terminals 20 each accommodated in the terminal accommodating chamber 22c from inside of the housing to the outside. Through each male terminal leading-out hole 22b, the tab 20a of each male terminal 20 projects forward beyond the front surface 22a of the rear section 22.

In each of the terminal accommodating chambers 22c, there is formed a lance 23 for locking the male terminal 20. The lance 23, like the lance 13 of the female housing 12, has a cantilevered beam-like shape extending from the bottom surface of the terminal accommodating chamber 22c toward the front side (the right side in FIG. 5A), and has an end portion from which a terminal locking projection 23a projects upward. The lance 23 is flexible in upward and downward directions to shift the terminal locking projection 23a between a locking position (the position shown in FIG. 1) for locking the male terminal 20 in a through hole formed in a bottom wall of the male terminal 20 and a lock-releasing position for retreating downward from the locking position.

The terminal accommodating chambers 22c and the lances 23 are molded in a die assembly and thereafter the die is pulled out forward, so that there are formed large openings in the front surface 22a of the rear section 22 for the terminal accommodating chambers, as shown in FIG. 5B.

The rear section 22 has a ceiling wall , which are formed with a temporal locking projection 22e and a complete locking projection 22f consecutively from the front side, and a collar portion 22h is formed on further rear side.

On the other hand, the front section 21 integrally includes a main body wall 21 a having a shape operable to cover the front surface 22a of the rear section 22, a peripheral wall 21b extending from a periphery of the main body wall 21 a i.e. toward the rear section 22, and a hood 26 extending in the opposite direction to the peripheral wall 21b. In other words, the front section 21 has a shape having the peripheral wall 21b and the hood 26 at the front and rear sides respectively, and is internally provided with the main body wall 21a.

The main body wall 21a has male terminal through holes 21c and the projecting portions 25 at positions corresponding to the male terminal leading-out holes 22b respectively Each male terminal through hole 21c has a diameter to allow a tab 20a of the male terminal 20 to be inserted thereinto without almost no gap. Each projecting portion 25 projects forward from the main body wall 21a and has a cylinder-like shape operable to cover a portion where the tab 20a is inserted into the male terminal through hole 21c (in other words, a portion behind the electric connection portion 20c), and has an outer diameter which allows the projecting portion 25 to come in close contact with the projecting portion 14b of the through hole 14a in the seal member 14 of the female connector C1 in an entire circumference.

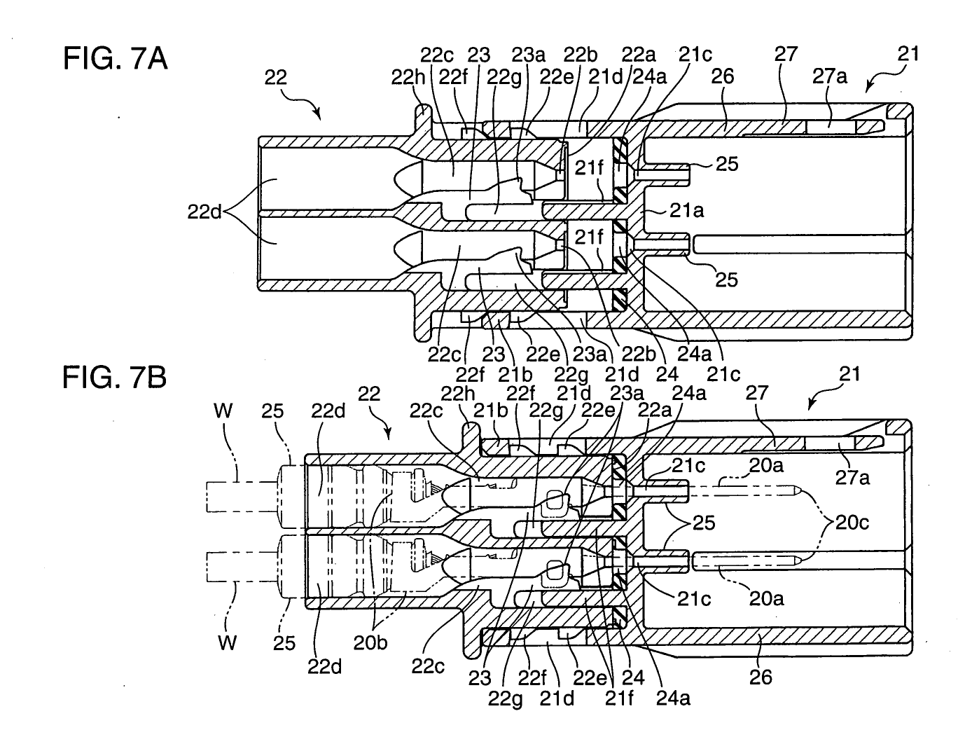

The peripheral wall 21b has a shape operable to fit at the outside of the front portion of the rear section 22, and is formed with elongate through holes 21d each extending in forward and backward directions in upper and lower portions. The elongate through holes 21d are formed at positions where the temporal locking projections 22e and the complete locking projections 22f of the rear section 22 can fit thereinto. The rear section 22 has a temporal locking position where only the temporal locking projections 22e fit into the respective elongate through holes 21d and a rear end of the peripheral wall 21b comes in contact with a front side surface of the complete locking projections 22f as shown in FIG. 7A, and a complete locking position where a rear end of the peripheral wall 21b fits into the elongate through hole 21d in addition to the temporal locking projection 22e to come in contact with the collar portion 22h as shown in FIG. 7B (in other words, the position where the front section 21 is attached to the rear section 22 completely).

The seal member 24 is formed out of an elastic material for sealing such as rubber or the like formed in the shape of a sheet and is fastened on substantially whole area of the rear side of the main body wall 21 a of the front section 21. The seal member 24 has through holes 24a formed at respective positions corresponding to the male terminal leading-out holes 22b and male terminal through holes 21c. Each through hole 24a has a shape a size larger than the tab 20a The seal member 24 comes in close contact with the front surface 22a of the rear section 22 when, as shown in FIG. 1 and FIG. 7B, the front section 21 is completely attached to the rear section 22 (in other words, retained at the complete locking position).

In the present embodiment, means for fastening the seal member 24 to the front section 21 is not especially limited. Means of press fitting, bonding or the like maybe used, and the seal member 14 may be integrally formed on the front section 21 by double-molding. Alternatively, the seal member 24 may be fastened on the side of the front surface 22a of the rear section 22.

On the other hand, the hood 26 has a cylinder-like shape operable to cover the tabs 20a of the male terminals 20. The hood 26 is formed with a flexible locking piece 27, which has an end portion formed with a locking hole 27a. When the connectors C1, C2 are connected each other as will be described hereinafter, the connector connection locking projection 12e of the female connector C1 fits into the locking hole 27a to lock the connection of the connectors C1, C2.

The male connector C2 according to the present embodiment has a further function of double locking of the male terminals 20.

Specifically, the front section 21 has a plurality of double-locking pieces 21f corresponding to the terminal accommodating chambers 22c. Each double-locking pieces 21f projects from the rear side of the main body wall 21 a backward in an axial direction (in other words, in a direction toward the rear section 22), penetrating the seal member 24. On the other hand, the rear section 22 is provided with insertion slots 12g each having a shape to allow the double-locking piece 21f to be inserted thereinto from the front side. The insertion slot 22g reaches a position immediately under the insertion slot 22g. Then, the front section 21 reaches the complete locking position while the double-locking pieces 21f are inserted to the respective insertion slots 22g. Thereby, each double-locking piece 21f penetrates under each lance 23 to hold the lance 23 at the locking position (in other words, at the position where the terminal locking projection 23a of each lance 23 is fit into a through hole of the male terminal 20.

### 3) Assembling Procedures and Action of Each of the Connectors C1, C2

Assembling procedures and action of each of the connectors C1, C2 are described herebelow.

First, in the female connector C1, the seal member holder 16 is held in the female housing 12 at the temporal locking position, as shown in FIG. 4A. In other words, the peripheral wall 16b of the seal member holder 16 fits at the outside of the front portion of the female housing 12 while each of the double-locking pieces 16f of the seal member holder 16 is inserted into the insertion slot 12g from the front side, and the holder locking projection 12f of the female housing 12 fits into the through hole 16e of the seal member holder 16. Then, each female terminal 10 crimped onto the terminal end of the electric wire W is inserted into each of the terminal accommodating chambers 12c from the rear side (in other words, through the rubber stopper press-in hole 12d).

At this time, the lance 13 is not retained by the double-locking piece 16f of the seal member holder 16. Accordingly, the lance 13 is flexibly deformed so as to be temporarily retracted while insertion of the female terminal 10 proceeds. When the insertion is completed, the lance 13 is elastically restored and the terminal locking projection 13a fits into the through hole formed in the bottom wall of the female terminal 10, thus locking the female terminal 10 on the side of the female housing 12. Further, the rubber stopper 15 into which an electric wire W is inserted is press-inserted into the rubber stopper press-in hole 12d to prevent immersion of water into the female housing 12 through the rubber stopper press-in hole 12d.

The seal member holder 16 is further pressed toward the rear side of the female housing 12 from the temporal locking position shown in FIG. 4A to reach the complete locking position (in other words, the position where the holder locking projection 12f fits into the rear end portion of the elongate through hole 16d) shown in FIG. 4B . Thereby, the seal member 14 retained by the seal member holder 16 comes in close contact with the front surface of the housing front wall 12a, and each double-locking piece 16f of the seal member holder 16 penetrates under the lance 13 to retain the lance 13 at the locking position. This achieves the double locking of each of the female terminals 10, and assembling of the female connector C1 is completed. If any female terminal 10 is not sufficiently inserted to reach the proper position at this point, the terminal 10 prevents the shift of a corresponding lance 13 to the locking position, thus precluding pressing the seal member holder 16 up to the complete locking position. This enables detecting the half-inserted state of the female terminal 10 in advance.

In other words, the female connector C1 can perform the double locking of the female terminals 10 while maintaining its waterproofing function sufficiently, with an extremely simple structure in which only the double-locking pieces 16f are added to the seal member holder 16 which retains the seal member 14 for individually waterproofing each terminal.

On the other hand, in the male connector C2, the front section 21 is retained by the rear section 22 of the male housing as shown in FIG. 7A at the temporal locking position. In other words, the peripheral wall 21b of the front section 21 fits at the outside of the front portion of the rear section 22 while the double-locking piece 21f of the front-section 21 is inserted into the insertion slot 22g from the side of the front surface 22a, and the temporal locking projection 22e of the rear section 22 fits into the elongate through hole 21e. Then, the male terminals 20 crimped onto respective terminal ends of the electric wires W in advance are inserted to the respective terminal accommodating chambers 22c from the rear side (in other words, through the rubber stopper pressing-in hole 22d).

At this time, the lance 23 is not retained by the double-locking piece 21f of the front section 21. Accordingly, the lance 23 is flexibly deformed to be retracted once to the lock-releasing position while the male terminal 20 is inserted. When the insertion is completed, the lance 23 is elastically restored in such a manner that the terminal locking projection 23a fits into the through hole formed in the bottom wall of the male terminal 20 to primarily lock the male terminal 20 on the side of the rear section 22. Further, the rubber stopper 25 to which an electric wire W is inserted is press-inserted into the rubber stopper pressing-in hole 22d to prevent immersion of water into the male housing through the rubber stopper pressing-in hole 22d.

The front section 22 is further pressed toward the rear section 21 from the temporal locking position shown in FIG. 7A to reach the complete locking position (in other words, the position where the complete locking projection 22f fits into the rear end of the elongate through hole 21d) shown in FIG. 7B. Thereby, the seal member 24 fastened to the front section 22 comes in close contact with the front surface 22a of the rear section 22, and each double-locking piece 21f of the front section 21 penetrates under the lance 23 to retain the lance 23 at the locking position. This achieves the double locking of the male terminal 20, and assembling of the male connector C2 is completed. If any male terminal 20 is not sufficiently inserted to reach the proper position, the terminal 20 prevents shift of a corresponding lance 23 to the locking position, thus precluding pressing the front section 21 up to the complete locking position. This enables detecting the half-inserted state of the male terminal 20 in advance.

The connectors C1, C2 which are assembled in such manner as described above are connected with each other to make respective pairs of terminals 10, 20 connected with each other waterproof individually and effectively. Specifically, as shown in FIG. 1, the electric connection portion 20c of the tab 20a of each of the male terminals 20 fits into the electric connection portion 10a of the female terminal 10 through the male terminal insertion hole 12b of the female housing 12 to make conduction between terminals 10, 20, while the projecting portion 25 formed on each of the male terminals 20 fits into the projecting portion insertion hole 16d of the seal member holder 16 to make close contact with a whole circumference of the seal projecting portion 14b in the through hole 14a in the seal member 14 , thus allowing the seal member 14 to prevent immersion of water into female housing 12 through the male terminal insertion hole 12b. Further, also in the male connector C2, even though the male housing is divided into the front section 21 and the rear section 22 for molding, each male terminal 20 is individually applied with waterproofing by the seal member 24 pressed between the portions 21,22.

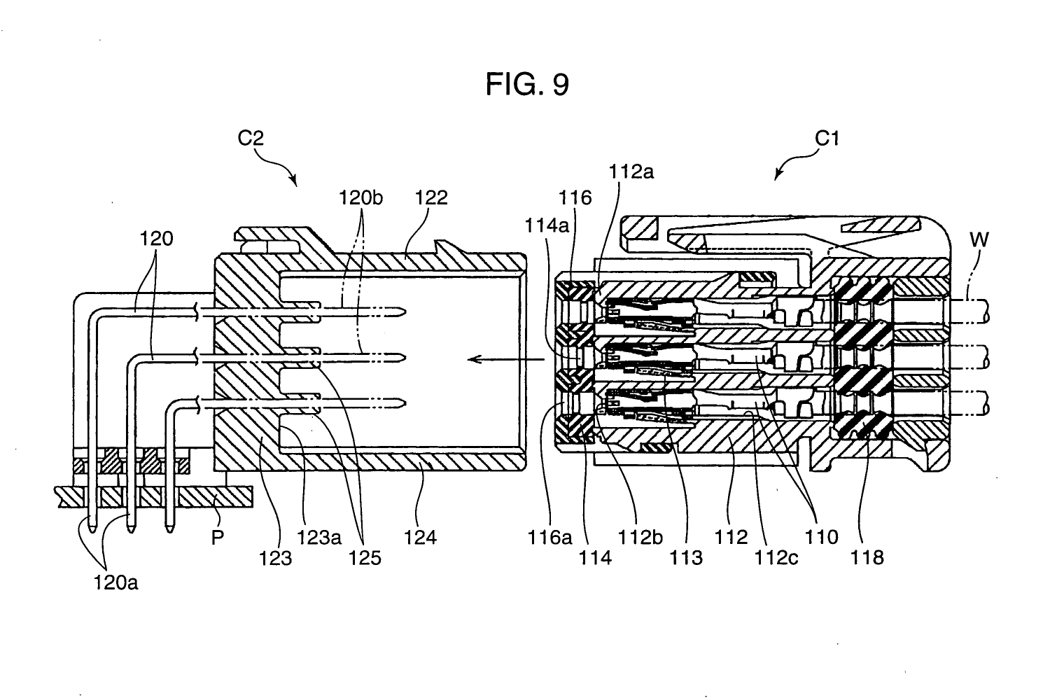

Regardless of a specific structure of a male connecter to be a mate of a female connector C1, the present invention can be widely used as long as the female connector C1 can preserve an individual waterproof function. For example, the male connector may be like the substrate-mountable male connector C2 as shown in FIG. 9, in which pin-like male terminals 120 are integrally molded with the male housing 122.

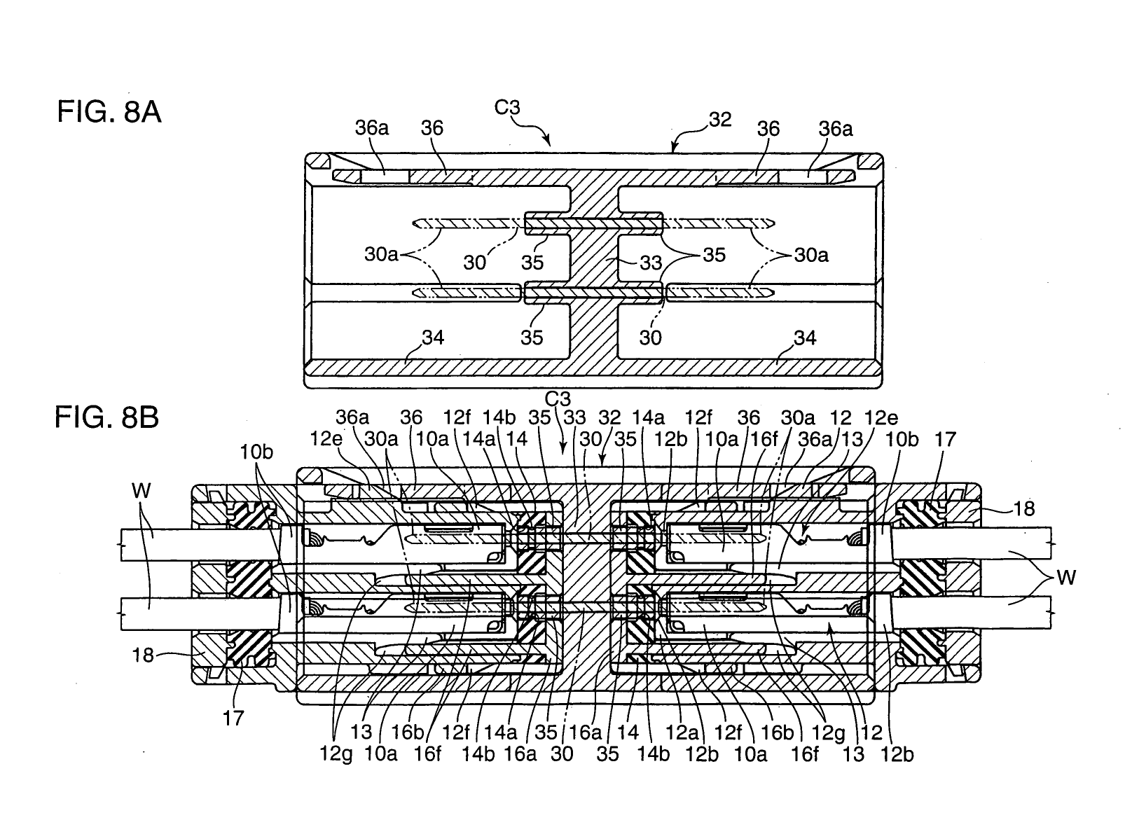

Alternatively, a relay connector C3 as shown in FIG. 8 can be used as a male connector so that two waterproof female connectors C1 each having a configuration which is same as that of the structure shown in FIGS. 1 to FIG. 4 are connected via the relay connector C3.

The relay connector C3 shown in FIG. 8 is formed by integrally molding a plurality of relay male terminals 30 corresponding to the respective female terminals 10 of the female connector C1 with an insulating housing 32. Each male terminal 30 has a pin-like shape having opposite ends as electric connection portions 30a, and an intermediate portion, which is retained by the insulating housing 32.

The insulating housing 32 integrally has a main body wall 33 extending in a direction perpendicular to its axial direction and a cylinder-like hood 34 extending toward opposite sides in an axial direction from a periphery of the main body wall 33. The male terminal 30 has an intermediate portion, which is retained by the main body wall 33 in a water-close state and in the state where each male terminal 30 penetrates through the main body wall 33 in its thickness direction, and both electric connection portions 30a of each male terminal 30 are covered with the hood 34 from the outer side. Further, a locking flexible piece 36 is formed in each hood 34, being formed with a locking hole 36a into which a connector connection locking projection 12e of each female connector C1 fit.

In the relay connector C3, the main body wall 33 has opposite side surfaces, which are formed with projecting portions 35, respectively. These projecting portions 35 are provided on respective male terminals 30 like the projecting portions 25 of the male connector C2 shown in FIG. 1. Each of the projecting portion 35 is formed to be a cylinder-like shape operable to cover a portion of the male terminal 30 on the rear side (on the side of -the main body wall 33) of the electric connection portion 30a, and has an outer diameter such that the projecting portion 35 is operable to come in close contact with a whole circumference of the seal projecting portion 34b of each through hole 34a in the seal member 34 of the female connector C1.

Further, in the example shown in the figure, as a waterproofing means for a rear portion of the female housing 12, there is used a plate-like seal member 17 into which an electric wire W is inserted in a close-contact state, instead of the seal rubber stopper 15 shown in FIG. 1. The seal member 17 is press-inserted into a rear chamber of the female housing 12, and a cover 18 is attached onto the outer side of the seal member 17.

In the waterproof connector as described above, both electric connection portions 30a of each male terminal 30 in the relay connector C3 and the electric connection portion 10a of the female terminal 10 in each female connector C1 fit with each other as shown in FIG. 8B, thus making electrical connection between the female terminals 10 of the female connectors C1 through the male terminal 30. At the same time, the projecting portions 35 on both sides of the main body wall 33 in the relay connector C3 comes in close contact with the seal projecting portion 34b of the seal member 34 in each female connector C1 to make it possible to prevent each female terminal 10 individually from the immersion of water into the female housing 12 through the male terminal insertion hole 12b of the female housing 12 in both female connectors C1.

Other than the above, the present invention can take the following embodiment

While, in the female connector C1 shown in FIG. 1 or the like, the double-locking piece 16f retains the lance 13 at the locking position to pursue the double locking of the female terminal 10, the double locking portion may lock the female terminal 10 directly (in other words, perform the double locking) at another position than the locking position of the female terminal 10 by the lance 13, for example.

A specific shape of the seal member holder 16 can be set preferably. For example, the peripheral wall 16b may be omitted while the double-locking piece 16f being locked on the side of the female housing 12.

The seal projecting portion 14b in the seal member 14 may be omitted so that the tab 20a of the male terminal 20 makes uniform contact with the seal member 14 at the entire through hole 14a in its axial direction. However, the seal projecting portion 14b as shown in the figure can reduce the frictional resistance against the male terminal being inserted.

As described above, according to the waterproof female connector of the present invention and a waterproof connector including the waterproof female connector, the seal member holder is given both a function of retaining a waterproof female-side seal member and a function of double locking of the female terminal while maintaining a fine waterproof function without making larger a size of the connector or complicating the structure.

Here, if the female housing includes a temporal locking portion which locks the seal member at a temporal locking position where the double locking portion of the seal member holder is inserted to the female housing but does not pursue the double locking of the female terminal, and a complete locking portion for locking the seal member holder at a complete locking position where the seal member holder is completely attached to the female housing, it is possible to retain a seal member for waterproofing retained by the seal member holder at the proper position (a position where the seal member makes close contact with the front surface of the female housing) and to pursue the double locking of the female terminals with a simple operation of inserting the female terminal into the terminal accommodating chamber of the female housing to lock with the terminal locking portion in the state where the seal member holder is temporarily locked in the female housing at the temporal locking position and thereafter shifting the seal member holder from the temporal locking position to the complete locking position.

If the terminal locking portion of the female housing is a lance which can be shifted between the locking position for locking the female terminal and the lock-releasing position for releasing the locking of the female terminal, and the double locking portion of the seal member holder retains the lance at the locking position to doubly lock the female terminal, it is possible of the double locking of the female terminal with a simple configuration of retaining the lance including the terminal locking portion at the locking position.

If the seal member includes a front side wall covering a front surface of the female housing and having a projecting portion insertion hole into which a projecting portion of the male housing can be inserted and a peripheral wall extending from a peripheral edge portion of the front side wall toward the female housing to be engaged with the outer surface of the female housing, and the seal member is fastened onto the back surface of the front side wall at a relative position where the projecting portion insertion hole of the front side surface and a through hole of the seal member are aligned, the peripheral wall of the seal member holder can protect the seal member fastened on the back surface of the front side wall of the seal member effectively from outer side and the seal member holder can be attached to the female housing smoothly and in a stable state by engaging the peripheral wall with an outer surface of the housing in such a manner as to insert the double locking portion projecting from the back surface of the front side wall into the female housing from the front surface side.

If there is formed a seal projecting portion projecting inward than other portion and operable to come in close contact with a projecting portion of the male housing in a whole periphery at a portion in an axial direction of an inner surface of each through hole of the seal member, the seal projecting portion can reduce frictional resistance against the male terminal being inserted.

1. A waterproof female connector which is to be connected with a male connector, the male connector being provided with a plurality of male terminals each having a front end portion as an electric connection portion, the male terminal projecting forward and held by a male housing, the male housing being formed with projections each projecting from a front surface of the male housing for a corresponding male terminal to cover a rear part of an electric connection portion, the waterproof female connector comprising:
a plurality of female terminals into which the electric connection portions of the male terminals can fit respectively;
a female housing including:
terminal accommodating chambers for accommodating the female terminals respectively;
terminal locking portions for locking the female terminals in the terminal accommodating chambers respectively; and
male terminal insertion holes into which the male terminals to fit into the female terminals can be inserted respectively, the male terminal insertion holes being formed in front of the female terminals;
a waterproof seal member made of an elastic material having a shape coming in close contact with a front surface of the female housing; and
a seal member holder for holding the waterproof seal member, the seal member being operable to be attached to the female housing in the state the waterproof seal member comes in close contact with the front surface of the female housing,
wherein: the waterproof seal member is formed with through holes corresponding to the respective male terminal insertion holes of the female housing and has a shape which allows an inner surface of the through hole to come in close contact with an outer surface of the projection of the male housing to prevent immersion of water into the male terminal insertion hole; and
the seal member holder has double-locking portions which are to be inserted into the female housing from a front side thereof when the seal member holder is attached to the female housing, the double-locking portions pursue double locking of the female terminals to the female housing in the state where the seal member holder is completely attached to the female housing.

2. The waterproof female connector according to claim 1, wherein the female housing includes:
a temporal locking portion for locking the seal member holder at a temporal locking position where the double-locking portion does not pursue the double locking of the female connectors while the double-locking portion of the seal member holder is inserted to the female housing;
and
a complete locking portion for locking the seal member holder at a complete locking position where the seal member holder is completely attached to the female housing.

3. The waterproof female connector according to claim 1, wherein:
each of the terminal locking portions includes a lance which can be shifted between a locking position for locking the female terminals and a lock releasing position for releasing the locking of the female terminals; and
the double-locking portion of the seal member holder pursues the double-locking of the female terminals by holding the lance at the locking position.

4. The waterproof female connector according to claim 1, wherein:
the seal member holder includes:
a front side wall operable to cover a front surface of the female housing, the front side wall having projection through holes into which the respective projections of the male housing can be inserted; and
a peripheral wall extending from a periphery of the front side wall toward the female housing to be engaged with an outer surface of the female housing;
the seal member is fastened onto the back surface of the front side wall at a relative position where the projection insertion holes on the front side surface and the through holes of the seal member correspond with each other; and
the double-locking portion projects from the back surface of the front side wall.

5. The waterproof female connector according to claim 1, wherein a raised seal portion is formed in a part of the inner surface of each through hole of the seal member in an axial direction, the raised seal portion protrudes inward than other part to come in close contact with entire periphery of the projection of the male housing.

6. A waterproof connector provided with the waterproof female connector according to claim 1 and a male connector which is operable to be connected with the waterproof female connector, the male connector comprising:
male terminals each having a front end portion formed as an electric connection portion operable to fit into each of the female terminals in the waterproof female connector; and a male housing for holding the male terminals so that a portion including the electric connection portion of each male terminal protrudes forward,
wherein: the male housing is formed with a projection protruding from a front surface for each position of the male terminals and covering a rear part of the electric connection portion of the male terminal; and
the projection is press-inserted into the through hole of the seal member of the female connector so that the outer surface of the projection comes in close contact with an inner surface of the through hole.
